(19) United States
(12) Patent Application Publication
(10) Pub. No.: US 2011/0280732 A1
(43) Pub. Date: Nov. 17, 2011

(54) Diffused Refractory Metal Alloy Coated Products

(76) Inventor: William D. Hurst, Ft. Pierce, FL (US)

(21) Appl. No.: 13/109,616

(22) Filed: May 17, 2011

Related U.S. Application Data
(63) Continuation of application No. 13/056,779, filed on Jan. 31, 2011.
(60) Provisional application No. 61/100,950, filed on Sep. 29, 2008.

(51) Int. Cl. F01D 5/14; B32B 15/01

(52) U.S. Cl. 416/223 R; 428/686

(57) ABSTRACT

A material is diffused into an electrically conductive substrate to enhance and add desirable properties through a metalliding process employing an electrolytic bath within an atmosphere substantially free of oxygen. The substrate to be coated is submerged within the bath as a cathode along with multiple anodes, each anode having a distinctive composition from the other. A variable power source provides preselected current densities to each of the anodes so as to result in a diffusing of material from each anode for coating the substrate in proportion to the current densities applied to each anode. Products of the invention include an electrically conductive substrate and an alloy coating diffused into a surface of the substrate, wherein the alloy coating comprises a compound of beryllium, boron or silicon, plus at least one refractory metal.

### CROSS-REFERENCE TO RELATED APPLICATIONS

This application is a continuation of U.S. application Ser. No. 13/056,779, filed Jan. 31, 2011, which claims the benefit of International Application No. PCT/US2009/058154, filed Sep. 24, 2009 which itself claims the benefit of U.S. Provisional Application No. 61/100,950, filed Sep. 29, 2008, the disclosures of which are hereby incorporated by reference herein in their entireties, and all commonly owned.

### FIELD OF THE INVENTION

The present invention generally relates to coating a base metal composition and in particular to metalliding including diffusing a base metal composition with two or more pre-selected metals in a fused salt bath

### BACKGROUND OF THE INVENTION

As is well known in the art and as discussed in the Scientific American, August 1969 publication article “Metalliding” by Newell C. Cook regarding his work at the General Electric Research and Development Center, the disclosure of which is herein incorporated by reference in its entirety, the association of one metal with another often results in properties that are superior to those of either metal alone. In addition to the traditional alloying (mixing die metals in the molten state) and plating (attaching one metal to the surface of the another), metalliding diffuses the atoms of one metal into the surface of another. The diffused metal becomes an integral part of the surface of the other metal, instead of being only mechanically attached to the surface as in plating. Metalliding is one form of alloying, except the alloy is only at the surface.

The diffusion is achieved by means of a high-temperature electrolytic process. The diffusing metal, serving as an anode, and the receptor metal, serving as a cathode, are suspended in a bath of molten fluoride salt. When a direct current passes from the anode to the cathode, the anode material dissolves and is transported to the cathode. There the anode material diffuses into the cathode, giving rise to an alloyed surface. As a result, a number of desirable changes in properties are achieved.

By way of example, the diffusion of boron into the surface of molybdenum produces a surface with a hardness approaching that of diamond. If silicon is diffused into molybdenum, the resulting material can be used in air for hundreds of hours at white heat, whereas untreated molybdenum burns in air at dull red heat and is rapidly destroyed. When beryllium is diffused into copper, the copper is made stronger, more resilient, harder and more resistant to oxidation while retaining its excellent electrical conductivity. Bonded steel may be made as hard as tungsten carbide, titanided copper resists boiling nitric acid and corrosion in air and tantalided nickel becomes almost as resistant to corrosive oxidation as pure tantalum.

As addressed by the Cook article, many benefits could be achieved if steel and other metals could be immersed in molten boron, silicon, chromium, titanium, tantalum and so on, but all of these metals melt at such high temperatures that the steel itself would melt on immersion in them. Metalliding provides a simple, practical and broadly applicable means of alloying metal surfaces.

Further, the molten-salt technique disclosed by Cook can be used with most of the metals on the periodic table as either the diffusing metal or the substrate.

The fluxing action of the molten fluorides dissolves from the surface of the cathode metal the oxide film that forms in air on all metals except gold and possibly platinum. Air oxide film on the surface of a metal is always a barrier to the diffusion of other metals into the substrate. The clean surfaces created by the fluoride solvents enable the atoms being electrolytically deposited to make direct contact with the atoms of the cathode's surface and allow diffusion to proceed at the maximum rate.

Boron and silicon are similar in reactivity, and so they are similar in the range of their applications as metalliding agents. The metals that can be bonded and silicidied include vanadium, chromium, manganese, iron, cobalt, nickel, copper, niobium, molybdenum, technetium, ruthenium, rhodium, palladium, sliver, tantalum, tungsten, rhenium, osmium, iridium, platinum, and gold. The list contains most of the familiar structural metals. Bedding and siliciding can be accomplished in a large number of salt mixtures but is usually done in a ternary compositional lithium fluoride, sodium fluoride and potassium fluoride.

Boride coatings are exceptionally hard. On steel, they usually fall between 1,500 and 2,500 on the Knoop scale, and often they exceed 3,000. On simple steels and many alloy steels the coating develops a root like attachment as the boron diffuses in; the coating is tightly anchored arid maintains its integrity even when the material is considerably deformed, The boride coatings usually have poor resistance to corrosion (except on stainless steels), but this can be remedied by lightly chromiding and siliciding the boride layer. Bonded steels show great promise for bearings and for dies. At their present stage of development, they are too brittle to be used as cutting tools.

The alloy surfaces are firmly bonded because the diffusing atoms penetrate the original structure and become part of it. The coatings are never porous because the original surface of the completely dense substrate is nonporous, and in accommodating the new atoms the structure of the substrate is only rear-ranged and expanded. The alloy coating can usually be formed with a high degree of electrolytic efficiency. Control of the coating's thickness can be quite precise. Most of the coatings are formed in thicknesses of from one mil (0.001 inch) to five mils in two to three hours. Some coatings develop more rapidly, becoming several mils thick in only a few minutes, and others form quite slowly, taking two or three days to attain a thickness of one or two mils. Almost without exception, increasing the temperature has speeded up the coating process. The alloys that are formed at the higher temperatures often have different properties, and sometimes less desirable ones. than the alloys formed at a lower temperature. As the temperature approaches the melting point of the substrate metal or of the alloy surface being formed, the rate of diffusion usually increases rapidly.

The fluoride solvent systems have a number of other advantages. First, they hold metalliding ions in solution. The alkali and alkaline earth fluorides combine with the fluorides of all other metals to produce soluble and highly stable fluometallate anions (negative ions). Hence the agents dissolve in the molten fluorides whether those agents are a solid with a high melting point or a gas, usually only a small amount (less than 1 percent) of the fluoride needs to be dissolved in the solvent fluoride for the metalliding reaction to take place. The solvent system can be varied according to the type of reaction desired. For example, it is usually advantageous to include potassium fluoride iii the solvent system for the siliciding and bonding reactions, fluorosilicate and fluoroborate ions are held much more tightly by potassium ions than by sodium and lithium ions.

Second, the alkali and alkaline earth fluorides do not form solvent cations that interfere with the alloying reaction. In general, the Group IA and Group IIA metals do not dissolve in or form compounds with the structural metals, primarily because the IA and IIA metals have atoms of comparatively large diameter. Therefore, fluoride salts of these metals are inert solvents for most metalliding reactions because metal atoms that are generated electrolytically from the salts do not dissolve in the surface of the cathode or react with it. Before they move many atomic diameters from the surface of the cathode they collide with fluometallate anions and promptly take away fluorine atoms. This liberates atoms, which then diffuse into the surface of the cathode.

Third, the fluoride solvents are excellent electrical conductors. They are so completely ionized in the molten state that current-carrying capacity has never been a limiting consideration in forming diffusion coatings. Moreover, the solvent fluorides are essentially noncorrosive, particularly when they are largely free of oxygen. They have still other advantages: they have low vapor pressure at operating temperatures, they resist displacement reactions by anode metals and they have a high surface tension (so that little of the all, is removed when a coaled piece is taken out of the metalliding bath). The properties and functions of the fluoride solvents are the salient technical features of the metalliding process. While most metalliding reactions will sustain themselves through a battery-like action of the internally generated electromotive force, an external electric current is usually imposed on the internal electromotive force, with the same direction of flow in order to achieve a more uniform and higher current density than the battery action will provide. In this way metalliding can proceed from three to 10 times faster than with the self-generated battery action without exceeding the rate at which the alloying agent can diffuse into the cathode substrate.

When the metalliding cell is operating as a battery, the polarity of the cathode is actually positive compared with the anode, whereas in plating the cathode is always more negative than the anode. When in metalliding an additional current is applied from an external source at a sufficiently low current (amperage) and diffusion occurs rapidly, the entire reaction can be run without the cathode's becoming negative. If the flow of current is interrupted during the applied current reaction, a rapid return of the cathode to positive polarity indicates that diffusion is keeping up with deposition. Failure of the cathode to return to a positive polarity indicates that the anode metal is starting to plate the cathode instead of diffusing into it.

### SUMMARY OF THE INVENTION

The present invention relates to improved methods for metalliding a base metal composition. The invention is further directed to processes for coating and/or diffusing a base metal composition with two or more pre-selected metals in a fused salt bath. A material may be coated to enhance and add desirable properties through a metalliding process employing an atmosphere substantially free of oxygen and an electrolytic bath within the atmosphere. An electrically conductive substrate to be coated is submerged within the bath as a cathode along with multiple anodes, each anode having a distinctive composition from each other. A variable power source provides distinctly selected current densities to each of the anodes so as to result in a coating of the substrate by each anode material in proportion to the applied current densities. It has been discovered that an extremely hard, corrosion and erosion resistant, uniform, adherent alloy coating can be formed on or diffused into a specific group of metals employing multiple low current densities, that is, total current densities in the range of 0.05-10 amperes/dm².

The present invention is herein described in an apparatus that may comprise an atmosphere substantially free of oxygen and an electrolytic bath within the atmosphere. An electrically conductive substrate having a surface thereof is at least partially submerged within the bath as is a plurality of elements. Each element is electrically conductive, and each has a distinctive composition from each other. An external power source is operable with the substrate and each of the plurality of elements. The power source provides a selected current density to each of the elements and to the substrate so as to result in a coating of the substrate by material from each of the plurality of elements within the bath in proportion to the current densities applied thereto.

A method aspect of the invention for applying a coating to a substrate may comprise providing an atmosphere substantially free of oxygen and an electrolytic bath within the atmosphere, submerging an electrically conductive substrate within the bath, submerging a plurality of electrically conductive elements within the bath, each element having a distinctive composition from each other, and providing a current density to each of the plurality of elements. The current densities are sufficiently imposed for coating the substrate with material from each of the plurality of elements within the bath in proportion to the current densities applied to each of the plurality of elements.

By way of example, niobium, tantalum, titanium, silicon and other metal boride intermetallic coatings and alloy coatings and diffusions may be formed on specified metal substrate compositions by forming an electric cell containing the metal composition as the cathode joined through a circuit having multiple external electrical connections to two or more anodes. By way of example for embodiments herein described, one anode may be boron and the other(s) may include the metal(s) required to form the alloy. A pre-selected fused electrolyte is used and may be maintained at a temperature of at least 600 C., by way of example, but below the melting point of the metal composition. This cell generates electricity, but a separate variable electromagnetic field or force (EMF) is impressed on each anode circuit portion to establish alloy percentages of each anode metal deposited on the cathode metal.

Variations in the direct current waveform have proved advantageous in certain applications. The total cathode current densities preferably do not exceed 10 amperes/dm². The anode metals diffuse into and/or onto the base metal to form an alloy coating or diffusion onto or into the substrate composed of the anode metals and/or the substrate metal. This process is useful in making coatings on the substrate metals.

Products of the invention may be described as a product comprising an electrically conductive substrate and an alloy coating diffused into a surface of the substrate, wherein the alloy coating comprises a compound of at least one of beryllium, boron and silicon, plus at least one refractory metal.

Further, a product of the invention may be described as comprising an electrically conductive substrate, and an alloy coating diffused into a surface of the substrate, wherein the alloy coating includes at least one of boron and silicon plus at least one refractory metal, and wherein the alloy coating diffusion resulted from submerging the at least one of the boron and the silicon, the at least one refractory metal, and the substrate in an electrolytic bath and applying a current density to each of the at least one of the boron and the silicon and the at least one refractory metal sufficient for coating the substrate with the alloy comprising the at least one of the boron and the silicon and the at least one refractory metal in proportion to the current densities applied thereto.

Yet further, a product of the invention may comprise an electrically conductive substrate and an alloy coating diffused into a surface of the substrate, wherein the alloy coating includes at least one of boron and silicon plus at least one refractory metal, and wherein the alloy coating diffusion resulted from submerging the at least one of the boron and the silicon, the at least one refractory metal, and the substrate in an electrolytic bath and applying a current density to each of the at least one of the boron and the silicon and the at least one refractory metal sufficient for coating the substrate with the alloy comprising the at least one of the boron and the silicon and the at least one refractory metal in proportion to the current densities applied thereto.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a diagrammatical schematic illustration of one embodiment of the invention including multiple elements forming anodes each operable with a voltage controller for providing a pre-selected alloy coating onto a substrate as the cathode;

FIG. 2 is a diagrammatical illustration of one embodiment including a two-element anode, one element of boron, a second of Niobium, within a bath for coating a stainless steel turbine blade;

FIG. 3 is a diagrammatical photo-micrographic image of a two-element alloy according to the teachings of the present invention illustrating niobium and boron on steel;

FIG. 4 is a perspective view a single blade having an alloy coating according to the teachings of the preset invention; and

FIG. 5 is a diagrammatical photo-micrographic image of a two-element alloy according to the teachings of the present invention illustrating tantalum and boron on steel.

### DETAILED DESCRIPTION OF THE PREFERRED EMBODIMENTS

The present invention will now be described more fully hereinafter with reference to the accompanying drawings, in which alternate embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

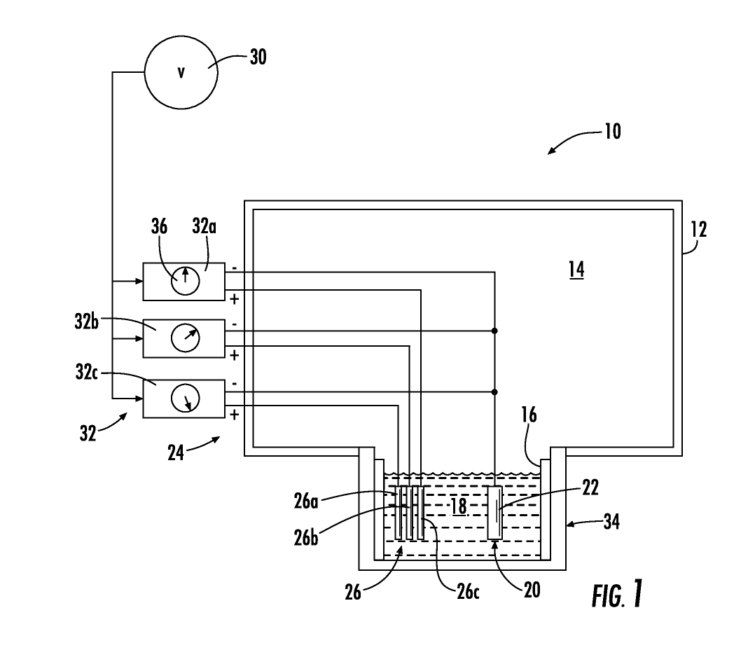

With reference initially to FIG. 1, one embodiment of the invention is herein described as an apparatus 10 comprising a housing 12 having an atmosphere 14 therein substantially free of oxygen. It has been found that an inert atmosphere and a vacuum provide effective environment for supporting the metalliding process. A container 16 positioned within the housing 12 includes an electrolytic bath 18. An electrically conductive substrate 20 includes a surface 22 to be coated submerged within the bath 18. As herein illustrated, the substrate 20 is a cathode for an electrical circuit 24 and a plurality of electrically conductive elements 26 is an anode within the circuit. Each element 26a, 26b, 26c of the anode has a distinctive composition from each other, as will be further detailed later in this section, and each has its surface 28 submerged within the bath 18.

With continued reference to FIG. 1, a power source 30 is connected to the substrate (cathode) 20 and to each of the plurality of elements (anode) 26. Yet further, the power source 30 is operable with rheostats 32 for providing a preselected current separately to each of the plurality of elements 26. By way of example, three rheostats 32a, 32b, 32c are herein described for providing a preselected current to their respective anode elements 26a, 26b, 26c for resulting in a current density to each of the elements 26 and the substrate 20. As a result, a metalliding reaction results and the substrate 20 is coated with material diffusing from each of the plurality of elements 26 within the bath 18 onto the substrate 20 in proportion to the current density applied to each of the plurality of elements 26. As will be understood by those of ordinary skill in the art, individual power sources may be employed for each of the separate anode elements 26. Yet further, the time required to apply the current will depend upon the source profile. By way of example, a half wave DC supply will typically need twice the time to apply the current density that a constant DC supply.

By way of example, the elements 26 forming the anode may include an atomic element, a metal, a non-metallic material, and/or an alloy.

In accordance with the teachings of the present invention, and with continued reference FIG. 1, one process includes pre-selected metals, as will be further detailed later in this section, employed as the anodes 26 and immersed in a fused salt bath comprising alkali metal fluoride mixtures or mixtures of the alkali metal fluorides with calcium fluoride, strontium fluoride, barium fluoride, potassium fluoride, sodium fluoride or lithium fluoride and containing from 0.1 to 15% mole percent of the appropriate anode fluoride. For one embodiment, the electrolytic bath comprises a fluoride salt. The bath may be fluorides of calcium, lithium, sodium, potassium, rubidium, and cesium, by way of example.

The cathode 20 employed is a base metal upon which a desired deposit is to be made. Under such conditions, the anode metals dissolve in the fused salt bath and anode metal ions are discharged at the surface of the base metal cathode where they form an alloy deposit and/or diffusion onto or into the base metal to form a metallic or inter-metallic coating and/or diffusion. As supported by the efforts of Newell C. Cook, above referenced, the apparatus 10 of FIG. 1 employed in metalliding reactions includes a metalliding agent, serving as the anode 26, dissolves in the molten fluoride bath 18, becoming positive ions because of the tendency of the fluoride in the solvent to capture electrons. At the cathode 20, which include a submerged metal that is to be coated, electrons from current flowing externally through the apparatus reduce the ions to atoms of the anode metal, which atoms then diffuse into the surface 22 of the cathode 20, giving the cathode/substrate 20 new properties. While examples using two anode elements are herein presented below, by way of example, it is understood by those skilled in the art that multiple anode elements may be employed as desired.

The rate of dissolution and deposition of the deposited material is not self-regulating in that the rate of deposition onto and into the base metal cathode 20 from each of the anode material elements 26 is dependent on the individual current externally applied.

The alkali metal fluorides used in accordance with the process may include the fluorides of lithium, sodium, potassium, rubidium and cesium. However, it is desirable when available to employ a eutectic mixture to operate this process at a relatively low temperature. Mixtures of the alkali metal fluorides with calcium fluoride, strontium fluoride or barium fluoride can also be employed as a fused salt in the process of this invention.

Attention to the chemical composition of the bath 18 is desirable if desirable coatings and/or diffusions are to be obtained. By way of example, the starting salt should be as anhydrous and as free of all impurities as is possible or should be easily dried or purified by simply heating during the fusion step. The process is desirably carried out in the substantial absence of oxygen since oxygen interferes with the process. As above described, the process may be carried out in an inert gas atmosphere or in a vacuum. By the term “substantial absence of oxygen” it is meant that neither atmospheric oxygen nor oxides of metals are substantially present in the fused salt bath. By way of further example, desirable results were obtained by using reagent grade salts and by carrying out the process under vacuum or an inert gas atmosphere, for example, in an atmosphere of argon, helium, neon, krypton, nitrogen or xenon.

It has been found that even commercially available reagent grade salts can be further purified to desirably operate the metalliding process. This purification can be readily done by utilizing scrap metal articles as the cathodes and carrying out the initial cleaning runs with or without an additional applied voltage, thereby plating out and removing from the bath those impurities which interfere with the formation of high quality coatings.

The base metals coated in accordance with the process of this invention may include all metals and alloys of those metals having a melting temperature of above 500° C. The form of the anode is not critical.

In order to produce a reasonably fast plating rate and to insure the coating and/or diffusion of the metals onto and/or into the base metal to form an alloy, it is desirable to operate the process at a temperature of from about 500° C. to 1100° C. It is useful to operate at temperatures of from 600° to 1100° C. The temperature at which the process is conducted is generally dependent to some extent upon the particular fused salt bath employed. Thus, for example, when temperatures as low as 600° C. are desired, a eutectic of potassium and lithium fluoride can be employed. Inasmuch as the preferred operating range for many coatings is from 900° C. to 1100° C., it is preferable to employ lithium fluoride as the fused salt. As illustrated with reference again to FIG. 1, a heater 34 is operable with the container 16 holding the bath 18.

The amount of current applied to each element 26 can be measured with an ammeter, which enables one to readily calculate the amount of anode(s) material being deposited on the base metal cathode and being converted to the alloy layer. Knowing the area and electrical characteristics of the article (substrate 20) being coated/plated, the thickness of the coating formed can be determined, thereby permitting accurate control of the process to obtain any desired thickness of the layer.

A voltage and thus the current applied may be varied to provide variable current densities during the reaction, and to increase and control the deposition rate of the alloy constituent coating being deposited without exceeding the diffusion and alloying rate of the anode(s) material into and onto the base metal cathode. By way of example, the voltage may not exceed 1.0 volt and may fall between 0.1 and 0.5 volts during one metalliding process.

Since the diffusion and coating rate of various anode materials into and onto the cathode article varies from one material to another with temperature, and with the thickness of the coating being formed, there is typically a variation in the upper limits of the current densities that may be employed. Therefore, the deposition rate of the alloying agents is adjusted so as not to exceed the diffusion and coating rate of the alloying agents into and onto the substrate material if high efficiency and high quality coatings are to be obtained. The maximum current density for a desirable alloy coating and/or diffusions is 10 amperes/dm.², when operating within the above addressed temperature ranges of this disclosure.

By way of further example, relatively low current densities (0.01-0.1 amperes/dm.²) are often employed when diffusion and coating rates are correspondingly low, and when very dilute surface solutions or very thin coatings are desired. The composition of the diffusion coating is changed by varying the current density of the individual anodes for producing a composition suitable for one application. Due to factors including a wide range of atomic sizes of elements, most extremely hard, corrosion and erosion resistant alloys cannot be created by layering one element on top of another, but must be delivered to the cathode substrate atom by atom in a correct proportion to create a desired alloy coating. The teachings of the present invention provide such desired alloy coatings.

Generally, current densities to form subjectively desirable quality alloy coatings and/or diffusions fall between 0.5 and 10 amperes per dm.² for the temperature ranges herein disclosed. When it is desirable to apply additional voltage to the circuit in order to shorten the time of operation, the total current density will not exceed 10 amperes/dm.², by way of example.

The power supply 30 (e.g. a battery or other source of direct current), is connected within the circuit 24 so that the negative terminal is connected to the base metal being coated, the cathode 20 and the positive terminal is connected to the anode 26. In this way, the voltages of both sources are algebraically additive. As will be readily apparent to those skilled in the art, measuring instruments such as voltmeters, ammeters, resistances, timers, and the like, may be included in the circuit to aid in the control of the process.

Because the extremely hard, tough, pore free, adherent corrosion and erosion resistant properties of coatings and diffusions are uniform over the entire treated area, the coated metal compositions prepared by the metalliding process herein described has a wide variety of uses. By way of example, the apparatus 10 as above described may be used to produce atomically bonded surface coatings such as niobium, titanium, tantalum and zirconium borides for wear and corrosion resistance, nuclear fuel rod layered zirconium boron applications and many other uses that will be readily apparent to those skilled in the art as well as other modifications and variations of the present invention in light of the above teachings.

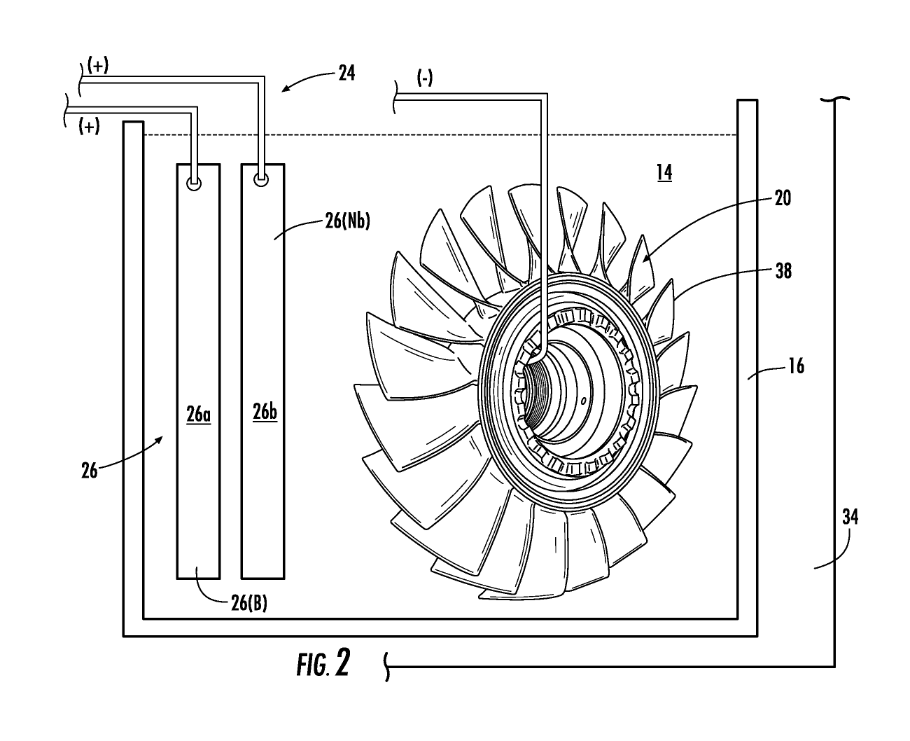

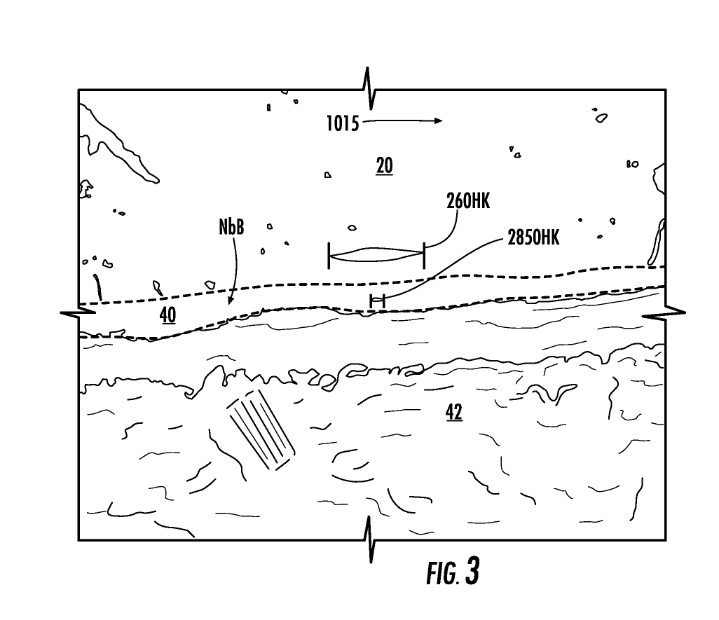

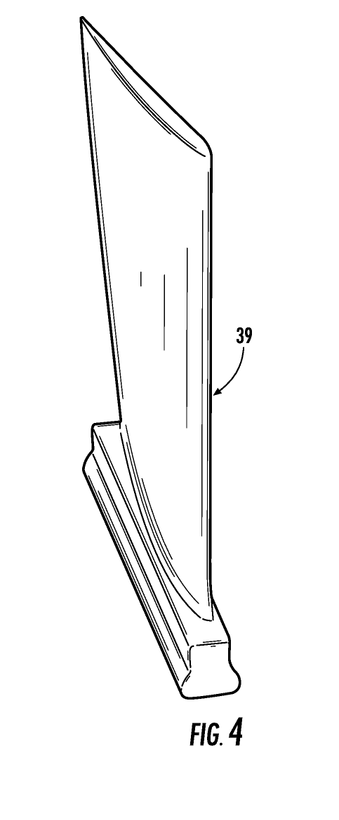

By way of example and with reference to FIG. 2, one embodiment of the invention includes a two-element anode element, one of niobium 26(Nb) and one of boron 26(B) providing a niobium boride coating to a surface of a gas turbine blade 38 as the substrate 20. Such turbine blades 38 are typically located in a front compressor section of an engine. A niobium boride coating 40, as applied using the teachings of the present invention, provides a thick atomically bonded coating of niobium and boron as a niobium boride alloy (NbB) on a 1015 stainless steel substrate/cathode 20 as illustrated with reference to FIG. 3. This coating 20 will be useful in covering both martensitic stainless blades as well as titanium blades illustrated with reference to FIG. 4. By way of example, if a alloy coating of niobium and boron as niobium boride (NbB) is desired, equal current densities are applied to each anode 26(Nb), 26(B). For anodes having equal surface areas within the bath, equal currents would be applied. Alternatively, an alloy coating of niobium boride (NbB₂), also referred to as niobium di-boride, may be desired. For this case, the current density for the boron anode 26(B) will be generally twice that applied to the niobium anode 26(Nb). Results have shown the current density generally has a linear relationship to the amount of anode material applied.

The economic benefits of this coating to the airline industry are considerable. An aircraft turbine engine will require a re-build every 8,000 to 15,000 hours depending on the make, model and age. The increase in fuel consumption due to loss of compressor efficiency from new to re-build or re-build to re-build is 5% or 2½% over the period. This loss is caused by erosion of the airfoil properties of the compressor blades. This erosion is due to the ingestion of airborne particles, particularly during landing and takeoff. The wear resistance of NbB is roughly 10 times that of unprotected blades and because of certain technical issues, (the fact that the coating is atomically bonded) would be granted FAA certification in less than 2 months. This fuel savings would save American Airlines alone, (700 aircraft) somewhere around 300 million dollars per year.

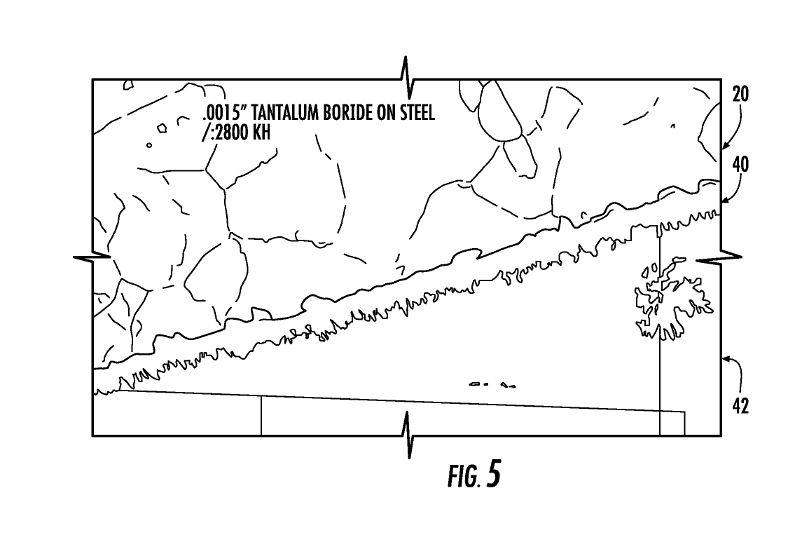

This NbB coating on titanium has other potential applications. Titanium is a suburb material but it has very poor erosion properties and some corrosion and friction (bearing) problems. A ½ thousandth coating would solve many of those problems as NbB is significantly harder than tungsten carbide and very, very corrosion resistant. As further illustrated with reference to FIG. 5, a tantalum boride coating 40 on a steel substrate 20 provides desirable results. For both diagrammatical photo-micrographic images of FIGS. 3 and 5 taken from actual photo-micrographic images, a fixture 42 used in testing the coated substrate is also shown, but is not intended to form a part of the claims invention.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and alternate embodiments are intended to be included within the scope of the claims herein presented.

That which is claimed is:

1. A product comprising:
a substrate, wherein the substrate is electrically conductive; and
an alloy coating diffused into a surface of the substrate, wherein the alloy coating comprises a compound of at least one of beryllium, boron and silicon, plus at least one refractory metal.

2. The product according to claim 1, wherein the substrate comprises at least one of a metal and an alloy.

3. The product according to claim 1, wherein the refractory metal is selected from a group consisting of molybdenum, niobium, tantalum, titanium and zirconium.

4. The product according to claim 3, wherein the alloy coating comprises a niobium boride compound.

5. The product according to claim 1, wherein the alloy coating comprises an intermetallic coating.

6. The product according to claim 1, wherein the substrate comprises at least one of one of steel and titanium.

7. The product according to claim 1, wherein the substrate comprises at least one of a turbine blade, a bearing, a die and a nuclear fuel rod.

8. The product according to claim 7, wherein the turbine blade comprises a gas turbine blade.

9. The product according to claim 1, wherein the substrate has a melting point greater than 500° C.

10. The product according to claim 1, wherein a process resulting in the diffusion includes submerging the substrate, boron and the at least one refractory metal in an electrolytic bath and applying a current density thereto sufficient for a dissolving thereof and the diffusing into the substrate in proportion to the current density applied to the boron and the at least one refractory metal.

11. The product according to claim 10, wherein the electrolytic bath comprises a fluoride salt.

12. The product according to claim 11, wherein the fluoride salt comprises at least one of fluorides of calcium, lithium, sodium, potassium, rubidium and cesium, strontium and barium.

13. The product according to claim 10, wherein the process is performed in at least one of an atmosphere substantially free of oxygen, an inert gas atmosphere and in a vacuum.

14. The product according to claim 13, wherein the inert gas atmosphere comprises at least one of argon, helium, neon, krypton, nitrogen and xenon.

15. The product according to claim 10, wherein the electrolytic bath has a temperature ranging from 500° C. to 1100° C.

16. The product according to claim 10, wherein the current density ranges from 0.5 to 10 amperes per dm².

17. The product according to claim 10, wherein the substrate is a cathode and the boron and the at least one refractory metal are anodes.

18. A product comprising:
an electrically conductive substrate; and
an alloy coating diffused into a surface of the substrate,
wherein the alloy coating includes at least one of boron and silicon plus at least one refractory metal, and
wherein the alloy coating diffusion resulted from submerging the at least one of the boron and the silicon, the at least one refractory metal, and the substrate in an electrolytic bath and applying a current density to each of the at least one of the boron and the silicon and the at least one refractory metal sufficient for coating the substrate with the alloy comprising the at least one of the boron and the silicon and the at least one refractory metal in proportion to the current densities applied thereto.

19. The product according to claim 18, wherein the substrate comprises at least one of one of steel and titanium.

20. The product according to claim 19, wherein the alloy coating comprises a niobium boride alloy.

21. The product according to claim 18, wherein the refractory metal is selected from a group consisting of molybdenum, niobium, tantalum, titanium and zirconium.

22. The product according to claim 18, wherein the substrate comprises at least one of a bearing, a die, a turbine blade and a nuclear fuel rod.

23. The product according to claim 22, wherein the turbine blade comprises a gas turbine blade.

24. The product according to claim 18, wherein the electrolytic bath comprises a fluoride salt.

25. The product according to claim 24, wherein the fluoride salt comprises at least one of fluorides of calcium, lithium, sodium, potassium, rubidium and cesium, strontium and barium.

26. The product according to claim 18, wherein the diffusion is performed in at least one of an atmosphere substantially free of oxygen, an inert gas atmosphere and in a vacuum.

27. The product according to claim 26, wherein the inert gas atmosphere comprises at least one of argon, helium, neon, krypton, nitrogen and xenon.

28. The product according to claim 18, wherein the electrolytic bath has a temperature ranging from 500° C. to 1100° C.

29. The product according to claim 18, wherein the current density ranges from 0.5 to 10 amperes per dm².

30. A product comprising:
an electrically conductive substrate; and
an alloy coating diffused into a surface of the substrate,
wherein the alloy coating includes boron and at least one refractory metal, and
wherein a process of the alloy coating diffusion resulted from submerging the boron, the at least one refractory metal, and the substrate in an electrolytic bath at temperature ranging from 500° C. to 1100° C., and applying a current density to each of the boron and the at least one refractory metal sufficient for coating the substrate with the alloy comprising the boron and the at least one refractory metal in proportion to the current densities applied thereto.

31. The product according to claim 30, wherein the substrate comprises at least one of a bearing, a die, a turbine blade and a nuclear fuel rod.

32. The product according to claim 30, wherein the refractory metal is selected from a group consisting of molybdenum, niobium, tantalum, titanium and zirconium.
